(19) United States
(12) Patent Application Publication
(10) Pub. No.: US 2009/0274421 A1
(43) Pub. Date: Nov. 5, 2009

(54) Optical semiconductor module, adjusting method thereof, and fabricating method thereof

(76) Inventors: Tatsurou Arayama, Kanagawa (JP); Yusuke Kurihara, Kanagawa (JP)

Correspondence Address: YOUNG & THOMPSON, 209 Madison Street, Suite 500, ALEXANDRIA, VA, 22314, US

(21) Appl. No.: 11/703,094

(22) Filed: Jun. 5, 2007

(30) Foreign Application Priority Data
Feb. 9, 2006 (JP) 2006-033021

(51) Int. Cl. G02B 6/36

(52) U.S. Cl. 385/88; 385/140

(57) ABSTRACT

An optical semiconductor module has: a semiconductor laser for radiating a laser beam; a lens for converging the laser beam; and an optical connector outputting the laser beam received from the lens to a transmission path. The optical connector has: a fiber ferrule including an optical fiber with an incident plane of the laser beam; and a light attenuator covering the incident plane. Transmittance of the laser beam through the light attenuator is varied according to rotation of the light attenuator on a plane perpendicular to an optical axis. The semiconductor laser, the lens and the optical connector are aligned such that a spot diameter of the laser beam on the incident plane is smaller than a diameter of a core of the optical fiber.

### BACKGROUND OF THE INVENTION

1. Field of the Invention

The present invention relates to an optical semiconductor module. In particular, the present invention relates to a technique for adjusting an output of an optical semiconductor module.

2. Description of the Related Art

There has been known an “optical semiconductor module” for use in transmitting light in the field of optical communications (see, for example, Japanese Laid-Open Patent Application JP-2004-205861, Japanese Laid-Open Patent Application JP-2004-138864 and Japanese Laid-Open Patent Application JP-H09-307144). The optical semiconductor module includes a semiconductor laser (a laser diode) serving as a light emitting device, and an optical connector for holding therein an optical fiber, wherein the semiconductor laser and the optical fiber are optically coupled to each other. For example, in a case where a receptacle is used as the optical connector, the optical semiconductor module is referred to as a “receptacle type optical semiconductor module”. The receptacle holds therein the optical fiber to be inserted from the outside, and further, it serves as a connector for positioning a light emitting device and a light receiving device with respect to the optical fiber.

FIG. 1 is a cross-sectional view schematically showing a configuration of a typical optical semiconductor module 100 of the receptacle type. The optical semiconductor module 100 includes a semiconductor laser 110 for radiating a laser beam, an optical lens 120 for converging the radiated laser beam, and a receptacle 130. The semiconductor laser 110 is mounted on a sub-mount 112 joined to a stem 111 by soldering or the like. The optical lens 120 is fixed to a lens cap 121, and the lens cap 121 is securely welded to the stem 111. A distance between the semiconductor laser 110 and the optical lens 120 is set to a predetermined value.

The receptacle 130 has a casing 131 and a fiber ferrule 132 securely fixed to the casing 131. The fiber ferrule 132 is constituted of a ferrule 133 and an optical fiber 134. The ferrule 133 is a cylindrical part for securely holding the optical fiber in the optical connector. The optical fiber 134 is an SMF (abbreviating “single mode fiber”) whose core has a diameter of about 10 micrometers. The laser beam converged by the optical lens 120 is coupled to the optical fiber 134 in the receptacle 130. The laser beam incident into an incident plane IP of the optical fiber 134 is output to a transmission path at the outside.

A slide holder 140 is a component part for connecting the unit including the semiconductor laser 110 and the optical lens 120 to the receptacle 130. The slide holder 140 can adjust the position of the receptacle 130 in an optical axis direction. Hereinafter, the optical axis will be referred to as a “Z-axis”. A plane perpendicular to the Z-axis will be referred to as an XY plane.

Alignment is first carried out in such a manner that a focus of the optical lens 120 accords with the incident plane IP. In other words, Z-axis alignment by using the slide holder 140 and X- and Y-axes alignments of the receptacle 130 are carried out, so that the position of the receptacle 130 is adjusted such that the incident plane IP accords with a “peak coupling position” at which the laser beam are most converged. However, in this case, an output intensity of the laser beam to be output from the optical fiber 134 may frequently be too high and exceed a desired output intensity (output specification). It is therefore necessary to attenuate the laser beam coupled to the optical fiber 134.

In view of this, “defocusing” has been conventionally performed, as disclosed in Paragraph 0044 in Japanese Laid-Open Patent Application JP-2004-205861 or in Paragraph 0011 in Japanese Laid-Open Patent Application JP-2004-138864. More specifically, the alignment in the Z-axis direction is deviated by lengthwise moving the receptacle 130 along the Z-axis direction, as indicated by an arrow in FIG. 1. That is to say, the position of the incident plane IP is intentionally deviated from the focus of the optical lens 120.

FIG. 2 shows a relationship between a defocusing quantity and a beam spot diameter on the incident plane IP. Moreover, FIG. 3 is a graph illustrating a relationship between the defocusing quantity and a normalized coupling efficiency. In FIGS. 2 and 3, a position at the defocusing quantity of 0 expresses a peak coupling position PC. The beam spot diameter is smallest at the peak coupling position PC, and is smaller than a diameter Rsmf (about 10 micrometers) of the core of the optical fiber 134 of the SMF. In this case, most of the laser beam converged by the optical lens 120 is coupled to the optical fiber 134, and therefore, the coupling efficiency becomes maximum.

As illustrated in FIG. 2, as a result of the defocusing, the beam spot diameter becomes larger in accordance with the defocusing quantity. When the beam spot diameter becomes larger than the diameter Rsmf of the core of the optical fiber 134, the laser beam coupled to the optical fiber 134 is reduced. As a consequence, the coupling efficiency is reduced as illustrated in FIG. 3: namely, the laser beam to be output from the optical semiconductor module 100 is attenuated. For example, the defocusing of about 0.5 mm attenuates the output by 6 dB.

In this manner, the output intensity of the laser beam to be output from the optical semiconductor module 100 is adjusted by the defocusing. When a desired output intensity is achieved, the receptacle 130 is positionally secured at the defocusing quantity. The receptacle 130 is secured by YAG laser welding or the like. In actual use, a fiber ferrule 200 is inserted into the receptacle 130 of the optical semiconductor module 100, as illustrated in FIG. 1. An optical fiber 201 included in the fiber ferrule 200 is optically coupled to the above-described optical fiber 134 in the receptacle 130. The laser beam is transmitted through the optical fiber 201.

### SUMMARY OF THE INVENTION

The present invention has recognized the following points. The optical fiber 201 to be inserted into the receptacle 130 may be either a single mode fiber (abbreviated as “SMF”) or a multiple mode fiber (abbreviated as “MMF”). The SMF is an optical fiber for transmitting a light beam in only one mode, and the diameter Rsmf of its core is about 10 micrometers. In contrast, the MMF is an optical fiber for transmitting a light beam in various modes, and a diameter Rmmf of its core is about 50 micrometers or about 62.5 micrometers (see FIG. 2).

The inventors of the present application have found that the intensity of the laser beam propagating through the optical fiber 201 is different between the SMF and the MMF in the case of the defocused optical semiconductor module 100. In the case where the MMF is inserted into the receptacle 130, the intensity of the laser beam becomes higher in comparison with the case where the SMF is inserted. As a consequence, characteristics may be varied according to the type of optical fiber in a system in which an arbitrary optical fiber is inserted into the receptacle 130. A technique is desired which is capable of making the optical output of the light propagating through the optical fiber 201 equal between the case of the SMF and the case of the MMF.

The above-described document (Japanese Laid-Open Patent Application JP-2004-138864) discloses that the amount of light is adjusted by rotating a built-in optical isolator. An optical isolator is often used in a distributed feed-back (abbreviated as “DFB”) laser which is relatively liable to undergo an influence of a reflecting return light, and further, is very expensive. Therefore, it is not practical to dare to install an optical isolator exclusively for the adjustment of the light amount in an optical semiconductor module which does not usually require any optical isolator.

The inventors of the present application have found that it is important not to carry out the defocusing in order to keep the output constant irrespective of the type of optical fiber to be inserted into the receptacle. The spot diameter of the laser beam is at least set to be smaller than the diameter Rsmf of the core of the SMF, and the alignment is achieved such that the coupling efficiency becomes maximum. However, in this case, the output intensity of the laser beam may possibly exceed a desired output intensity. In view of this, a light attenuator for attenuating the laser beam, which is different from an optical isolator, is provided according to the present invention.

An optical semiconductor module according to the present invention has: a semiconductor laser configured to radiate a laser beam; a lens configured to converge the laser beam; and an optical connector configured to output the converged laser beam received from the lens to a transmission path. The optical connector has: a fiber ferrule including an optical fiber with an incident plane of the laser beam; and a light attenuator covering the incident plane. The light attenuator is, for example, a polarizing glass. Transmittance of the laser beam through the light attenuator is varied according to rotation of the light attenuator on a plane perpendicular to an optical axis. It is possible by the rotation to attenuate the laser beam output from the optical semiconductor module.

The semiconductor laser, the lens and the optical connector are aligned such that the spot diameter of the laser beam on the incident plane becomes smaller than the diameter of the core of the optical fiber. That is, the defocusing quantity falls within a range in which the coupling efficiency is kept maximum, and therefore, no laser beam can be attenuated caused by the defocusing. In this case, the diameter of the core of the optical fiber to be inserted into the optical connector becomes irrelevant. The optical output of the light propagating through the optical fiber becomes almost constant irrespective of the SMF or the MMF to be inserted into the optical connector. Consequently, variations of the characteristics can be suppressed in the system in which an arbitrary optical fiber is inserted into the optical connector. In this manner, according to the present invention, it is possible to achieve the optical semiconductor module having a constant output irrespective of the type of optical fiber to be inserted.

According to the present invention, the output of optical semiconductor module can be constantly kept irrespective of the type of optical fiber to be inserted. Additionally, since no optical isolator is used for adjusting the amount of light, production cost can be reduced.

### BRIEF DESCRIPTION OF THE DRAWINGS

The above and other objects, advantages and features of the present invention will be more apparent from the following description taken in conjunction with the accompanying drawings, in which:

FIG. 1 is a cross-sectional view schematically showing a configuration of a conventional optical semiconductor module;

FIG. 2 is a graph illustrating a relationship between a defocusing quantity and a beam spot diameter on an incident plane;

FIG. 3 is a graph illustrating a relationship between a defocusing quantity and a normalized coupling efficiency;

FIG. 4 is a cross-sectional view schematically showing a configuration of an optical semiconductor module according to an embodiment of the present invention;

FIG. 5 is a graph illustrating dependency of transmittance upon rotational angle of a polarizing glass; and

FIG. 6 is a flowchart illustrating an output adjusting method and fabrication method of the optical semiconductor module according to the embodiment of the present invention.

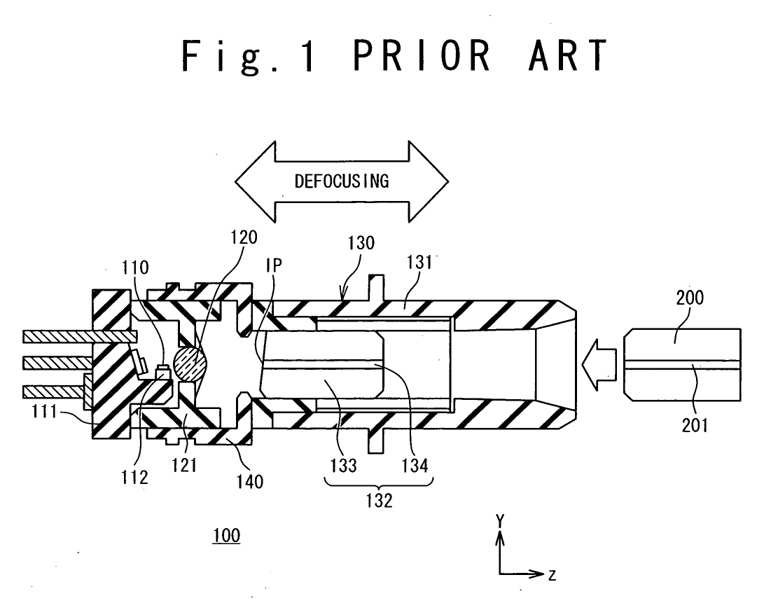

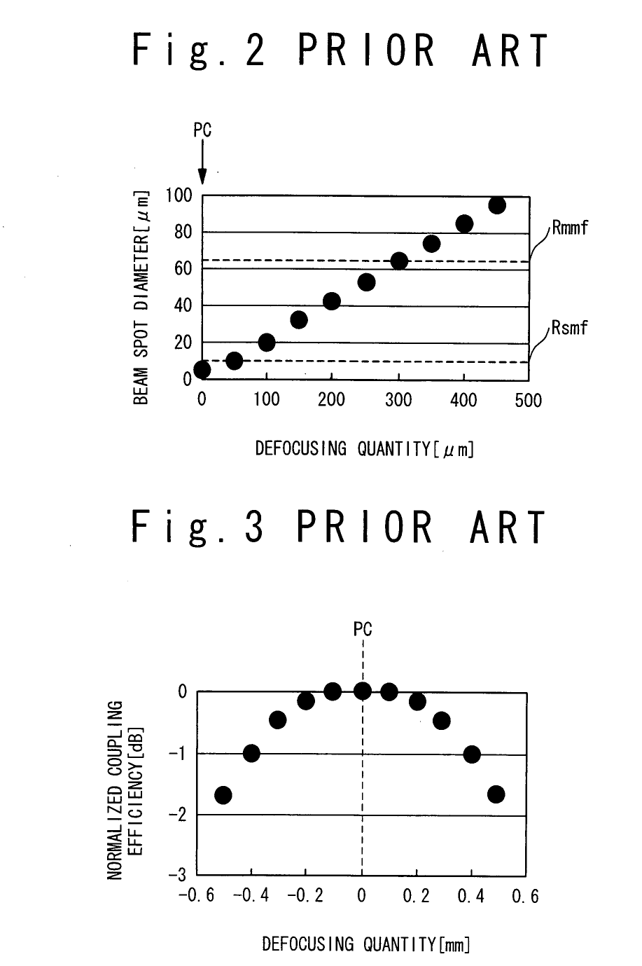

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

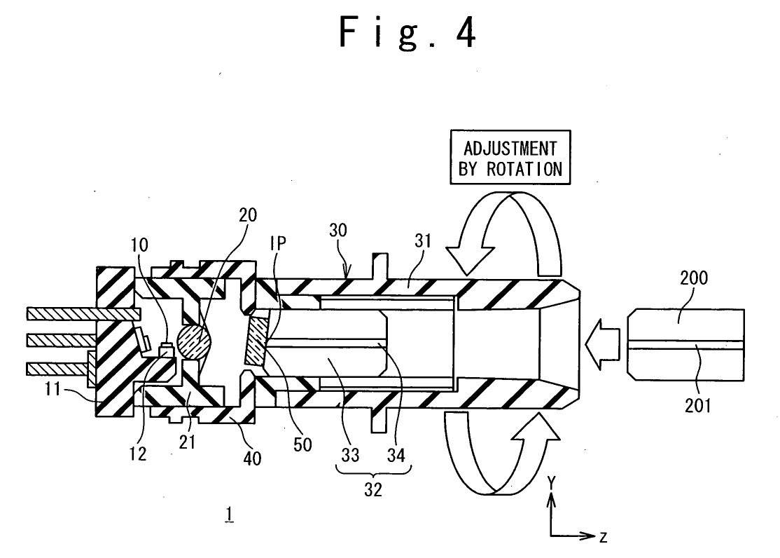

FIG. 4 is a cross-sectional view schematically showing a configuration of an optical semiconductor module 1 according to an embodiment of the present invention. The optical semiconductor module 1 is provided with a semiconductor laser 10, an optical lens 20, and a receptacle 30.

The semiconductor laser 10 is a laser diode for radiating a laser beam. In particular, it is preferable that the semiconductor laser 10 is a Fabry-Perot laser diode. The semiconductor laser 10 is mounted on a sub-mount 12 joined to a stem 11 by soldering or the like. The optical lens 20 converges the laser beam radiated from the semiconductor laser 10. The optical lens 20 is fixed to a lens cap 21, and the lens cap 21 is securely welded to the stem 11. A magnification of the optical lens 20 is desirably about 4×. A distance between the semiconductor laser 10 and the optical lens 20 is set to a predetermined value.

The receptacle 30 is an optical connector which holds therein a fiber ferrule 200 to be inserted from the outside. Moreover, the receptacle 30 optically couples the semiconductor laser 10 and an optical fiber 201 of the fiber ferrule 200 to each other. The receptacle 30 has a casing 31 and a fiber ferrule 32 securely fixed to the casing 31. The fiber ferrule 32 is constituted of a ferrule 33 and an optical fiber 34. The optical fiber 34 is a single mode fiber (abbreviated as “SMF”) whose core has a diameter Rsmf of about 10 micrometers. The laser beam converged by the optical lens 20 is coupled to the optical fiber 34 of the receptacle 30. The laser beam incident into an incident plane IP of the optical fiber 34 is output to a transmission path at the outside.

A slide holder 40 is a component part for connecting the unit including the semiconductor laser 10 and the optical lens 20 to the receptacle 30. The slide holder 40 can adjust the position of the receptacle 30 in an optical axis direction. Hereinafter, the optical axis will be referred to as a “Z-axis”. A plane perpendicular to the Z-axis will be referred to as an XY plane. Alignment is achieved by Z-axis alignment by using the slide holder 40 and X- and Y-axes alignments of the receptacle 30.

According to the present embodiment, the alignment is carried out in such a manner that the laser beam is not attenuated by the defocusing. In other words, the semiconductor laser 10, the optical lens 20 and the receptacle 30 are aligned such that the spot diameter of the laser beam on the incident plane IP becomes smaller than the diameter Rsmf (about 10 micrometers) of the core of the optical fiber 34. In this case, most of the laser beam converged by the optical lens 20 is coupled to the optical fiber 34, and therefore, the coupling efficiency becomes maximum (see FIG. 3). Preferably, the alignment should be carried out such that the focus of the optical lens 20 accords with the incident plane IP. That is to say, the receptacle 30 is positionally adjusted such that the incident plane IP accords with the peak coupling position PC at which the laser beam is most converged. In this case, the spot diameter of the laser beam on the incident plane IP becomes satisfactorily smaller than the diameter of the core of the optical fiber 34.

As described above, the defocusing quantity falls within a range in which the coupling efficiency is kept maximum, and therefore, no laser beam can be attenuated caused by the defocusing. In this case, the diameter of the core of the optical fiber 201 to be inserted into the receptacle 30 becomes irrelevant. In other words, the optical output of the light propagating through the optical fiber becomes almost constant irrespective of the SMF or the MMF to be inserted into the receptacle 30. Consequently, variations of the characteristics can be suppressed in the system in which an arbitrary optical fiber 201 is inserted into the receptacle 30. In this manner, according to the present embodiment, it is possible to achieve the optical semiconductor module 1 having a constant output irrespective of the type of optical fiber 201 to be inserted.

As described above, the defocusing is not substantially carried out according to the present embodiment. Therefore, the output intensity of the laser beam to be output from the optical fiber 34 may possibly exceed a desired output intensity (desired output specification) as it is. In view of this, the receptacle 30 according to the present embodiment is provided with a light attenuator 50 which covers the incident plane IP, as shown in FIG. 4. The light attenuator 50 is a member different from an optical isolator, and is a member for attenuating the laser beam coupled to the optical fiber 34. The transmittance of the laser beam through the light attenuator 50 is varied in accordance with rotation of the light attenuator 50 on the XY plane perpendicular to the Z-axis. It is possible by the rotation to adjust the output intensity of the laser beam to be output from the optical fiber 34.

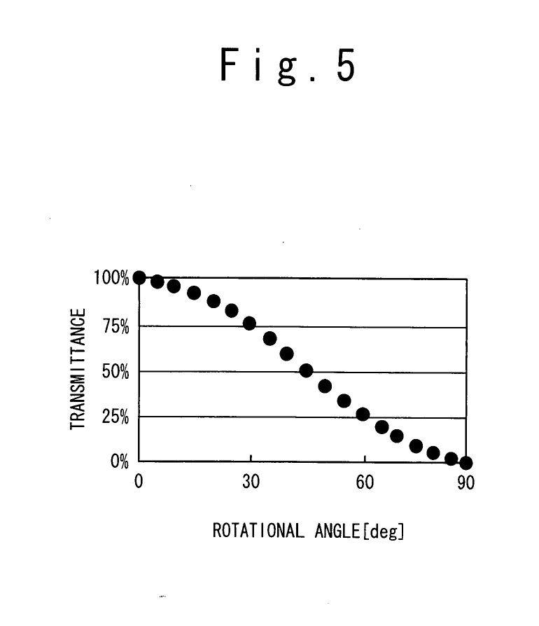

For example, the light attenuator 50 is formed of a polarizing glass which bi-directionally transmits the light beam. The polarizing glass 50 is adhesively bonded onto a side of the incident plane IP of the fiber ferrule 32 via a resin, and thus, is actuated integrally with the fiber ferrule 32. The amount of light transmitting through the polarizing glass 50 can be changed by rotating the polarizing glass 50, namely, the receptacle 30 on the XY plane (theta rotation). FIG. 5 is a graph showing a dependency of the transmittance on the rotational angle of the polarizing glass 50. As shown in FIG. 5, the transmittance becomes smaller as the rotational angle becomes larger. In this manner, it is possible by adjusting the rotational angle to optimize the output of the optical semiconductor module 1. For example, the theta rotation of about 60 degrees is carried out in order to attenuate the optical output by 6 dB.

The polarizing glass 50 is more inexpensive than the optical isolator, thereby is advantageous from the viewpoint of a fabrication cost. The optical isolator frequently used in the DFB laser which is relatively susceptible to an influence of a reflecting return light is very expensive. The optical semiconductor module 1 provided with the Fabry-Perot laser diode which is hardly susceptible to the influence of the reflecting return light requires no optical isolator. Therefore, it is not practical to install an optical isolator dedicated to the adjustment of the light amount in the optical semiconductor module 1. According to the present embodiment, no optical isolator is used for adjusting the amount of light, thereby achieving the optical semiconductor module 1 at a low cost. It should be noted that the light attenuator 50 is not be limited to the polarizing glass. A polarizing plastic, an optical filter, a reflecting plate or the like may be used as the light attenuator 50. Any member may be used as the light attenuator 50 as long as the member has the function of variably attenuating the light and has a variable attenuation quantity.

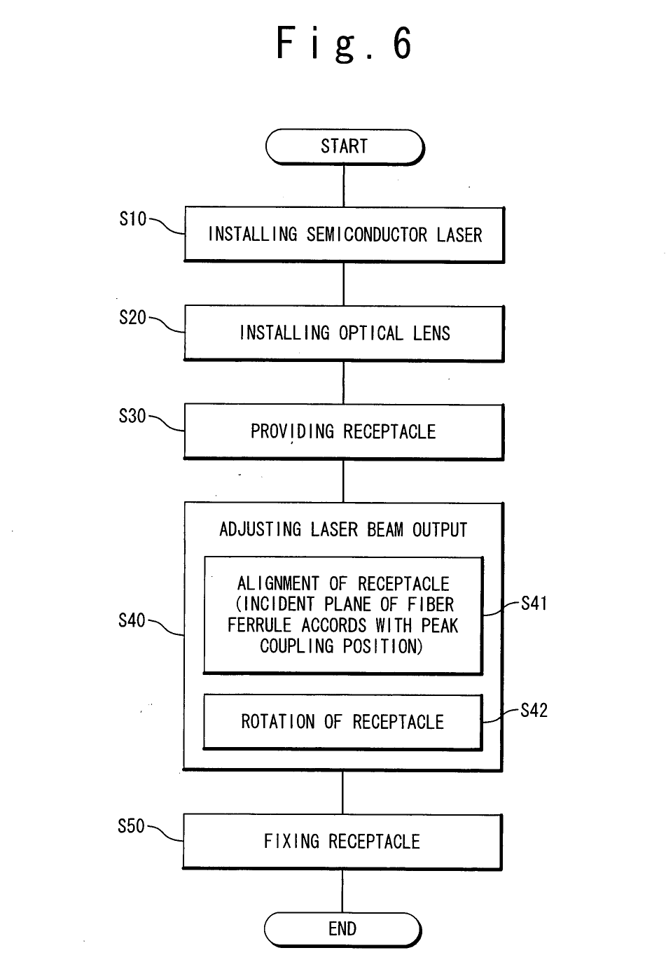

Next, an output adjusting method and a fabrication method of the optical semiconductor module 1 according to the present embodiment will be described with reference to FIG. 4 and a flowchart illustrated in FIG. 6.

First, the semiconductor laser 10 is installed on the sub mount 12, and the sub mount 12 is fixed to the stem 11 (holder) by soldering or the like (Step S10). Thereafter, the optical lens 20 is fixed to the lens cap 21, and the lens cap 21 is securely welded to the stem 11 (Step S20). The distance between the semiconductor laser 10 and the optical lens 20 is set to a predetermined value.

Next, the above-described receptacle 30 is provided (Step S30). The receptacle 30 includes the fiber ferrule 32 and the light attenuator 50. The fiber ferrule 32 is securely fixed to the casing 31, and further, the light attenuator 50 is adhesively bonded to the fiber ferrule 32 via the resin. Therefore, the light attenuator 50 can be rotated by rotating the receptacle 30 (casing 31).

Next, the laser beam output is adjusted (Step S40). First, the receptacle 30 is positionally adjusted by the alignment by the use of the slide holder 40 (Step S41). According to the present embodiment, the alignment is carried out such that the laser beam is not attenuated by the defocusing. More specifically, the position of the receptacle 30 is adjusted such that the spot diameter of the laser beam on the incident plane IP becomes smaller than the diameter Rsmf of the core of the above-described optical fiber 34. Preferably, the position of the receptacle 30 is adjusted such that the focus of the optical lens 20 accords with the incident plane IP. In this case, the incident plane IP accords with the peak coupling position PC.

Next, the receptacle 30 is rotated on the XY plane (Step S42). Since the light attenuator 50 also is rotated in accordance with the rotation of the receptacle 30, the transmittance is varied and the amount of light transmitting the light attenuator 50 is varied (see FIG. 5). It is possible by adjusting the rotational angle to set the output of the optical semiconductor module 1 to a desired value. Since the light attenuator 50 is rotated integrally with the receptacle 30 as described above, it is possible to easily adjust the laser beam output only by operating the receptacle 30. Furthermore, both of the positional determination of the receptacle 30 (Step S41) and the adjustment of the laser beam output (Step S42) can be carried out at the same time by operating only the receptacle 30, which is preferable.

After the desired laser beam output is achieved, the receptacle 30 is fixed to the holder (Step S50). The receptacle 30 is fixed by YAG laser welding or the like. In this manner, the optical semiconductor module 1 according to the present embodiment is constituted, and further, its output is adjusted.

As described above, according to the present invention, the adjustment of the amount of light by the defocusing is not carried out. Instead, the amount of light is adjusted by the rotation of the light attenuator 50. As a result, the output of the optical semiconductor module 1 can be kept constant irrespective of the type of optical fiber to be inserted. Although the optical connector is exemplified by the receptacle 30 in the above description, a pigtail can be used as the optical connector instead. Also in this case, a similar adjustment is carried out and hence similar effects are obtained.

It is apparent that the present invention is not limited to the above embodiment and may be modified and changed without departing from the scope and spirit of the invention.

What is claimed is:

1. An optical semiconductor module comprising:
a semiconductor laser configured to radiate a laser beam;
a lens configured to converge said laser beam; and
an optical connector configured to output said laser beam received from said lens to a transmission path,
wherein said optical connector has:
a fiber ferrule including an optical fiber with an incident plane of said laser beam; and
a light attenuator covering said incident plane and configured to attenuate said laser beam,
wherein said semiconductor laser, said lens and said optical connector are aligned such that a spot diameter of said laser beam on said incident plane is smaller than a diameter of a core of said optical fiber,
wherein transmittance of said laser beam through said light attenuator is varied according to rotation of said light attenuator on a plane perpendicular to an optical axis.

2. The optical semiconductor module according to claim 1,
wherein said semiconductor laser, said lens and said optical connector are aligned such that a focus of said lens accords with said incident plane.

3. The optical semiconductor module according to claim 1,
wherein said light attenuator is so provided as to be actuated integrally with said fiber ferrule, said fiber ferrule is fixed to a casing of said optical connector, and said transmittance is varied according to rotation of said optical connector on a plane perpendicular to an optical axis.

4. The optical semiconductor module according to claim 1,
wherein said light attenuator is a polarizing glass.

5. The optical semiconductor module according to claim 1,
wherein said semiconductor laser is a Fabry-Perot laser diode.

6. The optical semiconductor module according to claim 1,
wherein said optical connector is a receptacle.

7. The optical semiconductor module according to claim 1,
wherein said optical connector is a pigtail.

8. An optical connector comprising:
a casing;
a fiber ferrule fixed to said casing and including an optical fiber with an incident plane of a laser beam; and
a light attenuator covering said incident plane and configured to attenuate said laser beam,
wherein said light attenuator is so provided as to be actuated integrally with said fiber ferrule,
wherein transmittance of said laser beam through said light attenuator is varied according to rotation of said casing on a plane perpendicular to an optical axis.

9. The optical connector according to claim 8,
wherein said light attenuator is a polarizing glass.

10. A method of adjusting an output of an optical semiconductor module,
wherein said optical semiconductor module comprising: a semiconductor laser configured to radiate a laser beam; a lens configured to converge said laser beam; and an optical connector configured to output said laser beam received from said lens to a transmission path,
wherein said optical connector has: a fiber ferrule including an optical fiber with an incident plane of said laser beam; and a light attenuator covering said incident plane and configured to attenuate said laser beam,
wherein transmittance of said laser beam through said light attenuator is varied according to rotation of said light attenuator on a plane perpendicular to an optical axis,
said method comprising:
(A) adjusting a position of said optical connector such that a spot diameter of said laser beam on said incident plane becomes smaller than a diameter of a core of said optical fiber; and
(B) rotating said light attenuator on said plane such that an output from said optical semiconductor module becomes a desired value.

11. The method according to claim 10,
wherein in said (A) step, said position of said optical connector is adjusted such that a focus of said lens accords with said incident plane.

12. The method according to claim 10,
wherein said light attenuator is so provided as to be actuated integrally with said fiber ferrule, and said fiber ferrule is fixed to a casing of said optical connector,
wherein in said (B) step, said output is adjusted by rotating said casing on said plane.
